(19) United States
(12) Patent Application Publication
(10) Pub. No.: US 2012/0268342 A1
(43) Pub. Date: Oct. 25, 2012

(54) ELECTRONIC APPARATUS

(75) Inventor: Anwar SATHATH, Ome-shi (JP)

(73) Assignee: KABUSHIKI KAISHA TOSHIBA, Tokyo (JP)

(21) Appl. No.: 13/536,911

(22) Filed: Jun. 28, 2012

Related U.S. Application Data
(63) Continuation of application No. 12/954,311, filed on Nov. 24, 2010.

(30) Foreign Application Priority Data
Nov. 26, 2009 (JP) 2009-269147

(51) Int. Cl. H01Q 1/50

(52) U.S. Cl. 343/861

(57) ABSTRACT

According to one embodiment, an electronic apparatus includes an antenna, a switch circuit and a control circuit. The antenna is configured to have a first resonance frequency band and a second resonance frequency band. The switch circuit is connected between a feeder line and the antenna and configured to switch a resonance frequency band of the antenna from the first resonance frequency band to the second resonance frequency band in accordance with a control signal. The control circuit is configured to resonate with a transmission signal of the second resonance frequency band, which flows from a wireless communication module through the feeder line, and to generate the control signal by using energy which is obtained by the resonance with the transmission signal.

### CROSS-REFERENCE TO RELATED APPLICATIONS

This application is a continuation of U.S. application Ser. No. 12/954,311 filed on Nov. 24, 2010, which is based upon and claims the benefit of priority from Japanese Patent Application No. 2009-269147, filed Nov. 26, 2009; each of which are incorporated herein by reference in their entireties.

### FIELD

Embodiments described herein relate generally to an electronic apparatus, such as a personal computer, which includes an antenna.

### BACKGROUND

In recent years, various kinds of portable personal computers, such as notebook personal computer, have been developed. Most of these kinds of personal computers have wireless communication modules which enables wireless communication with external devices, such as other PCs, wireless access point, base station of mobile networks etc.

In addition, recently, the portable personal computer is required to have multi-band and or multiple antennas due to increase of channels available in mobile wireless communication systems and kinds of wireless communication systems.

Jpn. Pat. Appln. KOKAI Publication No. 2006-109184 discloses a wireless apparatus which has multiple antennas and a radio-frequency switch. In this wireless apparatus, the radio-frequency switch changes the antenna to be used from the multiple antennas, in accordance with a control signal which is received from a wireless control module.

However, in the above structure in which the antenna is changed over by using the control signal from the wireless control unit, hardware for generating the control signal has to be added to the wireless module, and the structure of the wireless module may possibly become complex. Furthermore, a control signal line for controlling the radio-frequency switch needs to be provided, in addition to a feeder line, between the wireless module and the radio-frequency switch, and a large mounting space may be occupied by the disposition of cables corresponding to these lines.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment;

FIG. 2 is an exemplary block diagram illustrating the system configuration of the electronic apparatus of the embodiment;

FIG. 3 is an exemplary circuit diagram illustrating the circuit structure of a resonance circuit provided in the electronic apparatus of the embodiment;

FIG. 4 is an exemplary view showing frequency characteristics of an antenna provided in the electronic apparatus of the embodiment; and

FIG. 5 is an exemplary view for describing an antenna control operation in the electronic apparatus of the embodiment.

### DETAILED DESCRIPTION

Various embodiments will be described hereinafter with reference to the accompanying drawings.

In general, according to one embodiment, an electronic apparatus comprises an antenna, a switch circuit and a control circuit. The antenna is configured to have a first resonance frequency band and a second resonance frequency band. The switch circuit is connected between a feeder line and the antenna and configured to switch a resonance frequency band of the antenna from the first resonance frequency band to the second resonance frequency band in accordance with a control signal. The control circuit is configured to resonate with a transmission signal of the second resonance frequency band, which flows from a wireless communication module through the feeder line, and to generate the control signal by using energy which is obtained by the resonance with the transmission signal.

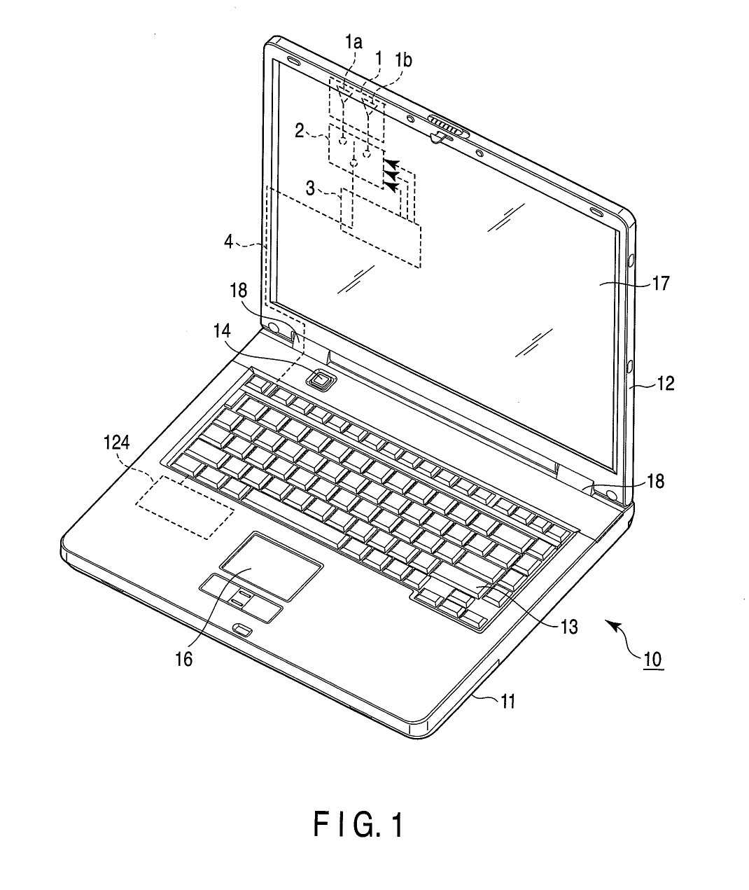

FIG. 1 shows the external appearance of an electronic apparatus according to an embodiment. The electronic apparatus is realized, for example, as a battery-powerable portable personal computer 10.

FIG. 1 is a perspective view of the computer 10 in the state in which a display unit of the computer 10 is opened. The computer 10 comprises a computer main body 11 and a display unit 12. A display device, which is composed of an LCD (Liquid Crystal Display) 17, is built in the display unit 12. The display screen of the LCD 17 is disposed on an approximately central part of the display unit 12.

The display unit 12 is rotatably attached to the computer main body 11 via a hinge portion 18. The hinge portion 18 is a coupling portion which couples the display unit 12 to the computer main body 11. Specifically, the display unit 12 is supported by the hinge portion 18 which is disposed on a rear end portion of the computer main body 11. The display unit 12 is attached to the computer main body 11 via the hinge portion 18 so as to be rotatable between an open position where the top surface of the computer main body 11 is exposed and a closed position where the top surface of the computer main body 11 is covered with the display unit 12.

In the display unit 12, an antenna 1 and a switch circuit 2 are provided. The antenna 1 and switch circuit 2 can function as a reconfigurable antenna which can vary a resonance frequency. Specifically, the antenna 1 has at least two (first and second) resonance frequency bands. The switch circuit 2 is connected between the antenna 1 and a feeder line 4. The switch circuit 2 functions as a frequency switching module which switches the resonance frequency band of the antenna 1, for example, from the first resonance frequency band to the second resonance frequency band, in accordance with a control signal. Examples of the structure of the antenna 1 are as follows.

(1) The antenna 1 includes a single antenna element. A position in the antenna element, at which the antenna element is grounded, is varied by the switch circuit 2. Thereby, the resonance frequency band of the antenna 1 is switched between the first resonance frequency band and the second resonance frequency band. For example, the first resonance frequency band may be selected during the period in which the switch circuit 2 is in the OFF state, and the second resonance frequency band may be selected during the period in which the switch circuit 2 is set in the ON state by the control signal.

(2) The antenna 1 includes an antenna element la and an antenna element 1b. The antenna element 1a covers the first resonance frequency band, and the antenna element 1b covers the second resonance frequency band. The switch circuit 2 switches the antenna element, which is connected to the feeder line 4, between the antenna element 1a and antenna element 1b in accordance with the control signal. For example, the antenna element 1a is selected during the period in which the switch circuit 2 is in the OFF state, and the selected antenna element 1a is connected to the feeder line 4. On the other hand, the antenna element 1b is selected during the period in which the switch circuit 2 is set in the ON state by the control signal, and the selected antenna element 1b is connected to the feeder line 4.

In the display unit 12, there is also provided a control circuit 3 which is connected to the feeder line 4 which is led to the display unit 12 from the main body 11 via the hinge portion 18. The control circuit 3 automatically generates the above-described control signal by using power of a transmission signal from a wireless communication module 124 which is provided in the main body 11.

For example, the case is now assumed in which the switch circuit 2 is configured such that the first frequency band (antenna element 1a) is selected when the switch circuit 2 is in the default state (i.e. when the switch circuit 2 is in the OFF state). In this case, the control circuit 3 is so designed as to resonate with a signal of the second resonance frequency band, in order to switch the state of the switch circuit 2 from the default state to the state in which the second frequency band (antenna element 1b) is selected (i.e. the switch circuit 2 is in the ON state). Specifically, the control circuit 3 is configured to resonate with a transmission signal of the second resonance frequency band, which flows from the wireless communication module 124 through the feeder line 4, and the control circuit 3 generates a control signal, which is to be supplied to the switch circuit 2, by using the energy obtained by the resonance with the transmission signal of the second resonance frequency band. If a wireless communication module, which wirelessly transmits and wirelessly receives signals of the first resonance frequency band, is provided in the main body 11, in place of the wireless communication module 124, the control circuit 3 does not generate the control signal. Thus, the state of the switch circuit 2 is kept in the default state in which the first frequency band (antenna element 1a) is selected. Hence, the control circuit 3 can adaptively vary the resonance frequency of the antenna 1 in accordance with the frequency band which is used for wireless communication on the system side, or in other words, in accordance with the wireless communication module which is mounted in the main body 11.

The computer main body 11 is a base unit having a thin box-shaped housing. A keyboard 13, a power button 14 for powering on/off the computer 10 and a touch pad 16 are disposed on the top surface of the computer main body 11. In the computer main body 11, there is provided a system board (also referred to as “motherboard”) on which various electronic components are disposed. The wireless communication module 124 is provided on the system board.

The wireless communication module 124 is a wireless communication module which executes wireless communication with an external device according to, for example, the third generation mobile communication system (3G). The wireless communication module 124 is connected, for example, to a bus slot which is provided on the system board. In the third generation mobile communication system (3G), for example, a frequency band of 850 MHz (824-894 MHz) or a frequency band of 900 MHz (880-960 MHz) is used. The 850 MHz band is used, for example, in Japan and in the U.S., and the 900 MHz band is used, for example, in Europe. According to the place of destination of the computer 10, either a wireless communication module which executes wireless communication using the 850 MHz band or a wireless communication module which executes wireless communication using the 900 MHz band, for instance, is mounted on the bus slot on the system board. In the description below, the case is assumed in which the wireless communication module 124 which executes wireless communication using the 850 MHz band is connected to the bus slot on the system board.

The antenna 1 is disposed, for example, at an upper end portion within the display unit 12. By disposing the antenna 1 at the upper end portion within the display unit 12, the wireless communication module 124 can execute wireless communication with the external device in the state in which the antenna 1 is disposed at a relatively high position.

The feeder line 4 is composed of a single cable such as a coaxial cable, and this cable is passed through the space within the hinge portion 18. The cable is led out from the computer main body 11 to the display unit 12 via the hinge portion 18.

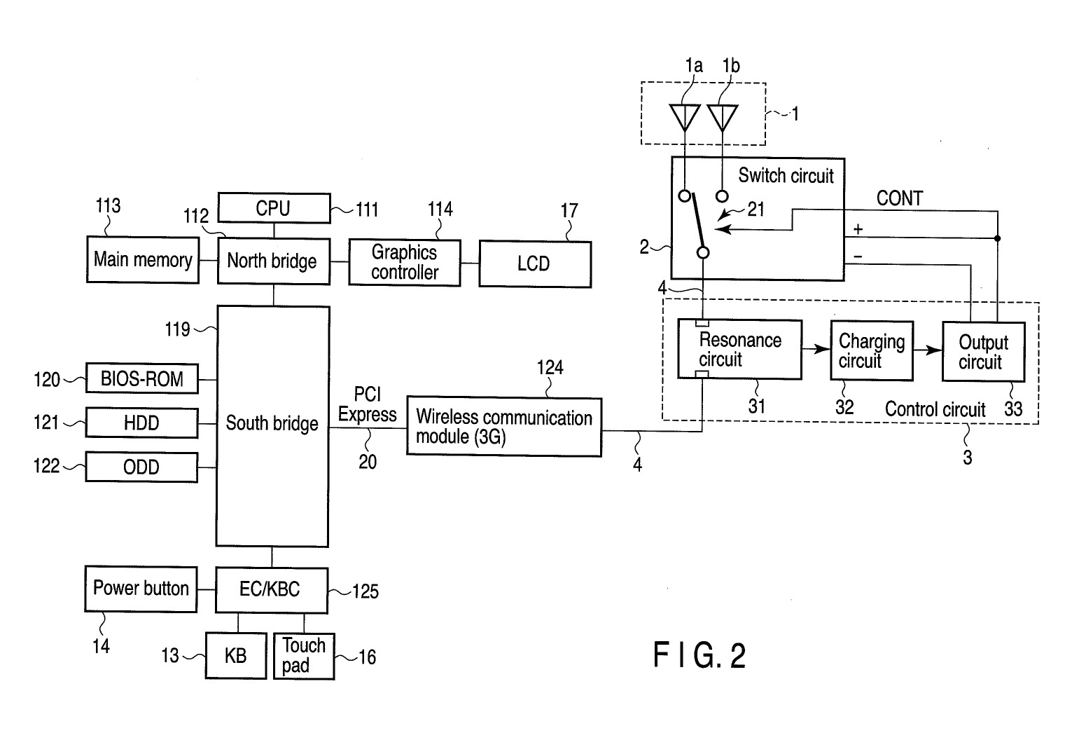

Next, referring to FIG. 2, the system configuration of the computer 10 is described.

The computer 10 comprises a CPU 111, a north bridge 112, a main memory 113, a graphics controller 114, a south bridge 119, a BIOS-ROM 120, a hard disk drive (HDD) 121, an optical disc drive (ODD) 122, wireless communication module 124, an embedded controller/keyboard controller IC (EC/KBC) 125, antenna 1, switch circuit 2 and control circuit 3.

The CPU 111 is a processor which controls the operation of the computer 10. The CPU 111 executes an operating system (OS) and various application programs, which are loaded from the hard disk drive (HDD) 121 into the main memory 113. The CPU 111 also executes a system BIOS (Basic Input/Output System) that is stored in the BIOS-ROM 120. The system BIOS is a program for hardware control.

The north bridge 112 is a bridge device which connects a local bus of the CPU 111 and the south bridge 119. In addition, the north bridge 112 has a function of communicating with the graphics controller 114 via, e.g. an AGP (Accelerated Graphics Port) bus.

The graphics controller 114 is a display controller which controls the LCD 17 that is used as a display monitor of the computer 10. The south bridge 119 is a bridge device which controls various I/O devices. The wireless communication module 124 is connected to the south bridge 119 via a bus 20 such as a PCI Express bus.

The wireless communication module 124 includes an antenna terminal for transmission and reception of wireless signals (RF signals). The antenna terminal of the wireless communication module 124 is connected to the antenna 1 via the feeder line 4 which is composed of a coaxial cable. The embedded controller/keyboard controller IC (EC/KBC) 125 is a one-chip microcomputer in which an embedded controller for power management and a keyboard controller for controlling the keyboard (KB) 13 and touch pad 16 are integrated.

The control circuit 3 generates, using transmission power from the wireless communication module 124, a control signal CONT for switch-controlling the switch circuit 2, and power for driving the switch circuit 2. The control signal CONT is used in order to control a switch, such as an FET, within the switch circuit 2. If the control circuit 3 is not present within the display unit 12, three lines (control signal CONT line, power line and ground line), as well as the feeder line 4, have to be led from the main body 11 side to the switch circuit 2 within the display unit 12, in order to control the switch circuit 2. In the embodiment, the control circuit 3 is configured to be able to automatically generate the control signal CONT, power (+) and ground (−), which are to be supplied to the switch circuit 2. Thus, it should suffice if only the feeder line 4 is led from the main body 11 side to the display unit 12.

The control circuit 3 includes, for example, a resonance circuit 31, a charging circuit 32 and an output circuit 33. The resonance circuit 31 is coupled to the feeder line 4, and is configured to resonate with a transmission signal of the second resonance frequency band (e.g. 850 MHz band), which flows from the wireless communication module 124 via the feeder line 4. In the case where the wireless communication module 124 executes wireless communication by using frequency-division multiplexing, the second resonance frequency band includes a transmission frequency band and a reception frequency band. In this case, the resonance circuit 31 may be configured so as to resonate with a signal of the transmission frequency band. The charging circuit 32 charges a capacitor within the charging circuit 32 by using the energy obtained by the resonance circuit 31 (the output current from the resonance circuit 31). The output circuit 33 supplies the control signal CONT, power (+) and ground (−) to the switch circuit 2 by using the power of the capacitor.

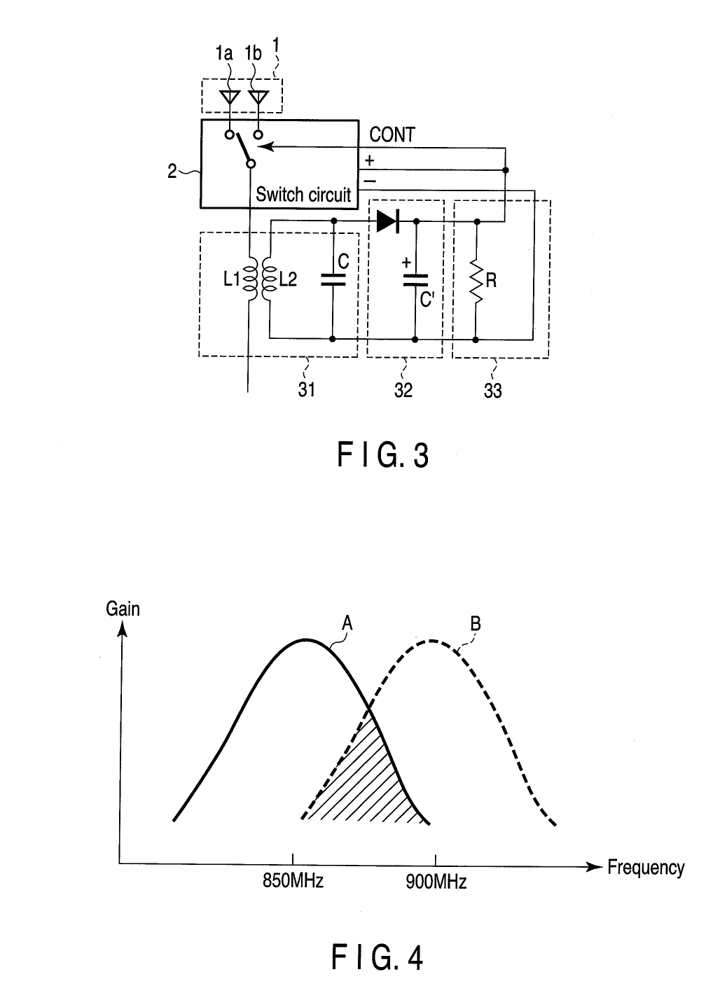

FIG. 3 shows an example of the structure of the control circuit 3. The resonance circuit 31 includes, for example, (a) an inductor L1 inserted in the feeder line 4, and (b) an LC resonance circuit comprising an inductor L2 and a capacitor C. The resonance frequency of the LC resonance circuit agrees with, for example, the frequency band of the transmission signal of the wireless communication module 124. The charging circuit 32 includes, for example, a diode D and a charge-accumulation capacitor C′. The charging circuit 32 can charge the charge-accumulation capacitor C′ by using the output current from the LC resonance circuit, only during the transmission period in which the wireless communication module 124 is transmitting the transmission signal. The output circuit 33 includes, for example, a resistor R, and generates, from the power of the charge-accumulation capacitor C′, the control signal CONT, power (+) and ground (−).

FIG. 4 shows an example of the two resonance frequency bands of the antenna 1. As shown in FIG. 4, the antenna 1 has two resonance frequency bands A and B. The antenna 1 is designed such that the two resonance frequency bands A and B partly overlap each other. Thereby, even during the period in which one resonance frequency band (e.g. resonance frequency band B) is selected by the switch circuit 2, the antenna 1 can receive a radio signal of the other resonance frequency band (e.g. resonance frequency band A). Thus, even when the switch circuit 2 is set in the default state in which the resonance frequency band B (900 MHz band) is selected, the wireless communication module 124 can receive a radio signal of the resonance frequency band A (850 MHz band). If the wireless communication module 124 begins to transmit the transmission signal of the resonance frequency band A (850 MHz band), the control circuit 3 starts charging the charge-accumulation capacitor C′ by using the power of the transmission signal. If the charge-accumulation capacitor C′ is charged, the control circuit 3 supplies the control signal CONT, power (+) and ground (−) to the switch circuit 2. As a result, the switch circuit 2 enables selection of the resonance frequency band A (850 MHz band).

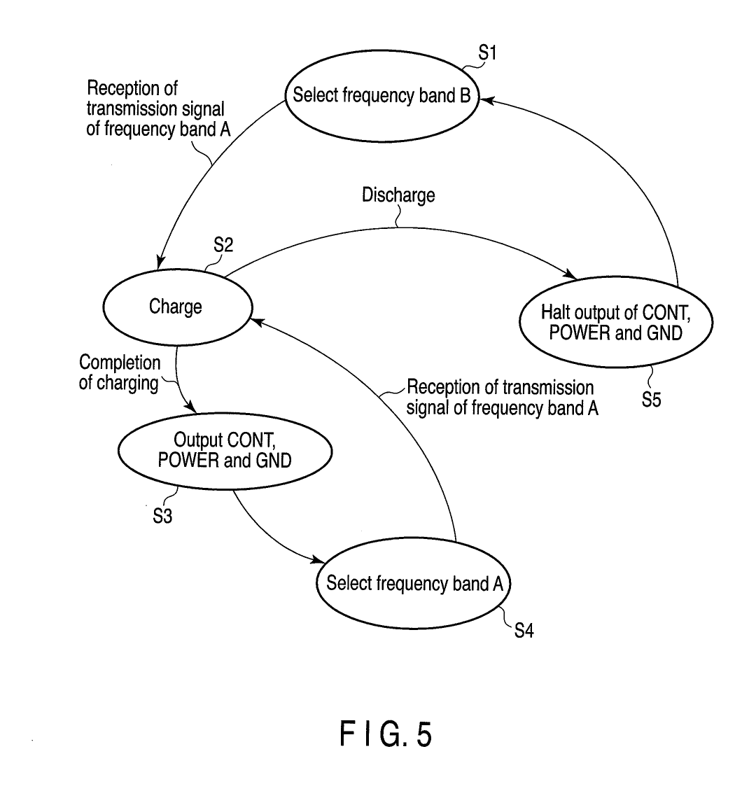

FIG. 5 shows an example of a frequency switching operation which is executed by the switch circuit 2 and control circuit 3.

In FIG. 5, a state S1 is a state (default state) in which the switch circuit 2 is in the OFF state. In the state S1, the resonance frequency band B of the antenna 1 is selected. A state S2 is a state in which the charge-accumulation capacitor C′ is being charged by using the transmission power of the resonance frequency band A from the wireless communication module 124. During the period in which the transmission signal of the resonance frequency band A is being output from the wireless communication module 124, the control circuit 3 is in the state S2. If the charging of the charge-accumulation capacitor C′ is completed, the control circuit 3 transitions to a state S3. In the state S3, the control circuit 3 supplies the control signal CONT, power (+) and ground (−) to the switch circuit 2. As a result, the switch circuit 2 is turned on, and the switch circuit 2 transitions to a state S4 in which the resonance frequency band A (850 MHz band) is selected.

If the transmission of the transmission signal of the resonance frequency band A from the wireless communication module 124 is absent for a certain time period or more, the charge-accumulation capacitor C′ is discharged, and the control circuit 3 transitions to a state S5. In the state S5, the control circuit 3 halts the output of the control signal CONT, power (+) and ground (−). As a result, the switch circuit 2 is turned off, and the switch circuit 2 transitions to the state S1 that is the default state.

As has been described above, according to the present embodiment, the control circuit 3 which is connected to the feeder line 4 controls the switch circuit 2 by using the transmission power of the wireless communication module 124. Thus, the resonance frequency band of the antenna can adaptively be controlled in accordance with the frequency band that is used for wireless communication. Therefore, the resonance frequency band of the antenna can automatically be controlled, without control from the system side.

In the embodiment, the control circuit 3 is configured to generate not only the control signal CONT to the switch circuit 2, but also the power (+) and ground (−) to the switch circuit 2. Alternatively, the power (+) and ground (−) to the switch circuit 2 may be supplied from the system side.

In the embodiment, the case of using the 3G wireless communication module as the wireless communication module has been described by way of example. However, the structure of the embodiment is applicable to any kind of wireless communication system.

Besides, in the embodiment, the example in which the structure of the embodiment is applied to the portable computer has been described. However, the structure of the embodiment is applicable to, for instance, mobile phones, PDAs, etc.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an antenna configured to have a first resonance frequency band and a second resonance frequency band;
a switch circuit connected between a feeder line and the antenna and configured to switch a resonance frequency band of the antenna from the first resonance frequency band to the second resonance frequency band in accordance with a control signal; and
a control circuit comprising a resonance circuit configured to resonate with a transmission signal of the second resonance frequency band, which flows from a wireless communication module through the feeder line, the control circuit configured to generate the control signal by using energy which is obtained by the resonance with the transmission signal.

2. The electronic apparatus of claim 1, wherein the control circuit comprises a charging circuit configured to charge a capacitor by using the energy obtained by the resonance, and the control circuit is configured to supply power to the switch circuit from the capacitor.

3. The electronic apparatus of claim 1, wherein the second resonance frequency band partly overlaps the first resonance frequency band.

4. The electronic apparatus of claim 1, further comprising:
a main body comprising a system which comprises the wireless communication module; and
a display unit attached rotatably to the main body,
wherein the antenna, the switch circuit and the control circuit are provided within the display unit.

5. The electronic apparatus of claim 4, wherein the display unit is attached to the main body via a coupling portion, and the feeder line is led from the main body to the display unit through the coupling portion.

6. An electronic apparatus comprising:
a main body;
a wireless communication module provided within the main body;
a display unit attached rotatably to the main body via a coupling portion;
an antenna provided within the display unit and configured to have a first resonance frequency band and a second resonance frequency band;
a switch circuit provided within the display unit, connected between the antenna and a feeder line, which is led from the main body to the display unit through the coupling portion, the switch circuit being configured to switch a resonance frequency band of the antenna from the first resonance frequency band to the second resonance frequency band in accordance with a control signal; and
a control circuit provided within the display unit and comprising a resonance circuit configured to resonate with a transmission signal of the second resonance frequency band, which flows from the wireless communication module through the feeder line, the control circuit configured to generate the control signal by using energy which is obtained by the resonance with the transmission signal.

7. The electronic apparatus of claim 6, wherein the control circuit comprises a charging circuit configured to charge a capacitor by using the energy obtained by the resonance circuit, and an output circuit configured to supply power for driving the switch circuit and the control signal to the switch circuit by using power of the capacitor.
